(19) United States
(12) Patent Application Publication
(10) Pub. No.: US 2008/0271286 A1
(43) Pub. Date: Nov. 6, 2008

(54) Door Braking Device

(75) Inventor: Carl Stalhammar, Goteborg (SE)

Correspondence Address: WRB-IP LLP, 1217 KING STREET, ALEXANDRIA, VA, 22314, US

(73) Assignee: VOLVO LASTVAGNAR AB, Göteborg (SE)

(21) Appl. No.: 11/718,605

(22) PCT Filed: Nov. 4, 2004
(86) PCT No.: PCT/SE04/01608

§ 371 Date: Feb. 29, 2008

(51) Int. Cl. E05F 5/08; E05C 17/20; E05F 3/02

(52) U.S. Cl. 16/84; 16/85

(57) ABSTRACT

A door braking device for the door of a vehicle, in particular a truck, includes a bar movable between an extended position in which the door is fully opened, and a retracted position in which the door is closed, and a brake surface being biased towards the movable bar by a spring member providing a recoil force being proportional to a recoil length of the spring member, such that the brake surface exerts a brake force on the movable bar for braking a movement of the door. At least one link member is pivotably arranged to transmit the recoil force from the spring member to the brake surface, wherein the link member has at least a minimum pivotal position corresponding to a minimum contribution to the recoil length of the spring, and a maximum pivotal position corresponding to a maximum contribution to the recoil length of the spring being greater than said minimum contribution to the recoil length, the minimum and maximum contributions to the recoil length resulting in a minimum and a maximum contribution to the resulting brake force, respectively.

### BACKGROUND AND SUMMARY

The invention relates to a door braking device for a door of a vehicle, in particular a truck, said door braking device comprising a bar being movable between an extended position in which the door is fully opened, and a retracted position in which the door is closed, and a brake surface being biased towards the movable bar by means of a spring member providing a recoil force being proportional to a recoil length of the spring member, such that the brake surface exerts a brake force on the movable bar for braking a movement of the door.

Door stopper devices for vehicles serve to brake the movement of the door during opening or closing thereof. The braking prevents the door being flung open or closed for example when the vehicle is parked on a slope or when there is wind that might otherwise catch the door and act so as to open/close it. The door stopper devices often include a series of braking sessions along the opening path of the door, so as to accomplish different positions in which the door may be left open without risk for unintentional change of position. This is particularly useful when there is not enough space to open the door completely, such as, e.g., in parking lots.

One type of prior art door stopper device includes a bar being attached to the door, and being extendible from a housing arranged on the chassis of the vehicle when the door is opened. In the housing, a roller is arranged to be biased towards the bar by means of a spring resulting in the roller exerting a braking force on the bar.

With prior art devices, it is sometimes experienced that the braking force is too high. For example, when the vehicle is parked on a slope, the force needed to close the door has to overcome both the gravity acting on the door and the braking from the door stopper device. When closing the door from within, the user's arm is extended to reach the door, which is why it might be particularly difficult to generate the required closing force.

For vehicles, in particular for trucks where the doors are relatively large and heavy, it is advantageous if the door may be opened to a great extent but is still easy to close. Also, the door should have a brake behaviour allowing controlled opening/closing of the door during difficult conditions such as on slopes or in windy weather. For trucks, it is particularly important to have a door braking device that brakes the movement of the door in case the door is not completely closed when the driver's cab is tilted forwardly. Unless the braking device is sufficiently efficient in this situation, there is a risk that the heavy door is flung open and thereby damages the hinges and the chassis adjacent to the door. Further, a door braking device should preferably have a long life span.

It is desirable to provide a door braking device for a door of a vehicle, being advantageous in at least one of the above mentioned aspects.

A door braking device according to an aspect of the invention is provided, wherein at least one link member is pivotably arranged to transmit the recoil force from the spring member to the brake surface, wherein the link member has at least a minimum pivotal position corresponding to a minimum contribution to the recoil length of the spring, and a maximum pivotal position corresponding to a maximum contribution to the recoil length of the spring being greater than said minimum contribution to the recoil length, said minimum and maximum contributions to the recoil length resulting in a minimum and a maximum contribution to the resulting brake force, respectively.

The pivotal link member provides a possibility of controlling the recoil length of the spring, and thus the braking force obtained, using the pivotal position of the member. This possibility enables constructions where the maximum recoil length of the spring may be relatively great, while the overall construction of the braking device may be made rather compact, without need of excessive space. The use of a relatively long maximum recoil length of the spring has the advantage that a relatively weak spring may be used, since the long maximum recoil length compensates for the relatively low spring constant resulting in a sufficiently high brake force to efficiently brake the door. Further, the existence of the different positions is a prerequisite for using an advantageous brake release device, as will be explained later on.

The recoil length is, as defined in the introduction, the length to which the recoil force of the spring member is proportional. It could be, e.g., a compression length or an extension length of a spring member from an unstrained state. The pivotal positions of the link member contribute to the total recoil length of the spring member. The total recoil length could be influenced by other devices or arrangements than the link member, giving other contributions to the total recoil length and thus to the resulting brake force.

With the term “brake surface” is meant the surface being in contact with the movable bar and being effective to transmit a braking force in a certain situation. Thus, the “brake surface” is not necessarily associated with one single defined device or surface. Instead, the physical feature forming the brake surface might vary in different situations. However, the brake surface is the surface being in contact with the movable bar. Also, the “brake surface” need not be a continuous surface, but could be formed from several individual surface parts.

The pivotal link has a minimum and a maximum pivotal position. However, it is to be understood that the link could have several minimum and maximum positions, as well as intermediate positions.

Advantageously, the movable bar has an outer profile towards which the brake surface is biased, said outer profile having at least one indentation, and movement of the bar with said indentation past the brake surface results in a transition between said minimum and maximum pivotal positions of the link member. Accordingly, the outer profile of the bar is used to control the pivotal position of the link member, and its contribution to the recoil length of the spring member.

Preferably, the link member is arranged in relation to the indentation such that the link member will assume its maximum position when at least a part of the brake surface is in contact with the indentation. This particular arrangement provides advantages regarding the friction and force distribution in between the brake surface and the bar, which may be used so as to obtain a desired rotation pattern of the link member. Also, it presents advantages when combined with a brake release device, as will be described below.

The link member may be arranged in relation to the brake surface, such that a distance between the pivotal centre of the link member and the brake surface measured in the recoil direction of the spring when the link member is in said minimum pivotal position is less than the corresponding distance when the link member is in said maximum pivotal position.

Advantageously, the link member may be formed as a pivotal link wheel having a pivotal centre, and having a maximum radius extending from the pivotal centre to a brake surface, and a minimum radius extending from the pivotal centre to a second brake surface. Thus, the variation between the maximum radius and the minimum radius may be transferred so as to influence the recoil length of the spring. As will be explained below, the direct “output” from the wheel being the difference between the minimum radius and the maximum radius may nevertheless be amplified before reaching the spring.

The link wheel may be pivotable from a first maximum pivotal position to a minimum pivotal position and further to a second maximum pivotal position by pivoting in one direction only. This is advantageous since, when the bar is moved, e.g., extended for opening of the door, it will move in one direction. Via the brake surface, the unidirectional movement of the bar may be transmitted to a pivoting of the link wheel, also in one direction. When the link wheel may be pivoted between several maximum positions, several sessions with maximum brake force on the bar may result, giving possibilities to furnish the opening of the door with several stop/brake positions.

The link wheel may advantageously be arranged so as to be rotable. In this case, it may be designed so that only one maximum pivotal position appears on one revolution of the link wheel. However, and as is more preferred, the link wheel may also be designed so that several maximum pivotal positions occur during one revolution of the link wheel. This enables use of a larger wheel while still obtaining a desired number of stops during the length of the movable bar. A larger wheel may in turn provide a larger contribution to the recoil of the spring.

Advantageously, the link wheel may have at least two maximum radii corresponding to two maximum positions, said maximum radii being equidistant radii extending from the pivotal centre, and said link wheel having a minimum radius extending from the pivotal centre of the link wheel perpendicular to the intersection of a straight imaginary axis between the outer end points of the maximum radiuses. This configuration enables two equal maximum positions to be reached during one revolution of the link wheel. It is to be understood that an additional number of maximum positions may be arranged during one revolution, by providing the link wheel with additional radii of the maximum length.

In the above-mentioned case, the link wheel may comprise at least two bar contact means for contacting the movable bar and providing said brake surface, said bar contact means being arranged at equidistant radii from the rotational centre of the link wheel. Preferably, the minimum position may then be a position in which both bar contact means contact the movable bar, and the maximum position is a position in which only one of said bar contact means contacts the movable bar. It is to be understood that there could be other bar contact means arranged in between the two bar contact means as described above.

Advantageously, the link wheel comprises three bar contact means being arranged to form the corners of an equilateral triangle. A pivotal or rotational centre of the link wheel may be situated in the centre of the triangle.

The bar contact means as described above need not be separate physical devices, but could be parts of one physical entity. However, providing the bar contact means as separate physical devices is preferred. It is particularly advantageous to provide the bar contact means so as to comprise a rotational roller. The roller will allow movement of the bar without being subject to excessive wearing, and nevertheless provide the desired braking force.

The link member may form an effective lever arm for transmitting the spring force to the brake surface, such that the resulting brake force exerted on the movable bar is greater than the spring force produced by the spring member. A link member forming an effective lever arm could be a link member simultaneously forming a lever wheel as described above, where the radii of the wheel form effective lever arms for transmitting the spring force to the brake surface. However, a link member forming an effective lever arm could also be another member, such as a conventional lever. The link member forming an effective lever arm amplifies the spring force produced by the spring member to the resulting brake force.

Preferably, the brake system may comprise a first link member being a link wheel and a second link member in the form of a lever arm upon which the link wheel is rotably arranged. In this configuration, the minimum and maximum positions of the link wheel will result in movement of the rotational centre of the link wheel. This movement may be amplified via the lever arm so as to contribute to the recoil length of the spring.

The lever arm may be pivotally suspended and extend a first distance from the pivotal suspension to the spring member and the link wheel may be rotably arranged on the lever arm at a second distance from the pivotal suspension thereof, said second distance being shorter than said first distance.

A door brake device according to the invention may advantageously be provided with a release actuator device being arranged to disable transmission of the spring force to the movable bar when the pivotal link is in said minimum position. Preferably, the release actuator device is arranged to affect the spring member for disabling transmission of the spring force to the movable bar.

This is advantageous since the force needed to disable the transmission of the spring force when the pivotal link is in the minimum position is less than the force needed when the link is in the maximum position. Accordingly, a relatively large brake force may be achieved when the link member is its maximum position, but the force needed to disable the transmission is diminished.

The release actuator device may preferably be a pneumatically driven device. As such, the release actuator may be coupled to a conventional pneumatic system in a vehicle, which is an economical and practical solution. Since a conventional pneumatic system has a limited capacity, the diminishing of the force needed to disable the transmission is of importance to enable use of the pneumatic system for the release actuator.

Advantageously, the release actuator device may be a piston of a pneumatic cylinder being arranged to compress the spring member via the link arm.

Preferably, the door braking device may be arranged such that, when the door is in its most open position, the link member is in its minimum position.

Accordingly, the brake may advantageously be disabled when the door is in its most open position.

### BRIEF DESCRIPTION OF THE ACCOMPANYING DRAWINGS

Other features and advantages of the present invention will appear more clearly from the following description of exemplary embodiments, wherein

FIG. 1 is a perspective view of an embodiment of a door braking device according to the invention.

FIG. 2 is an exploded view of the door braking device of FIG. 1.

FIG. 3 is a sectional view of the door braking device of FIG. 1 when the door is in a closed position.

FIG. 4 is a sectional view of the door braking device of FIG. 1 when the door is in a first stop position.

FIG. 5 is a sectional view of the door braking device of FIG. 1 when the door is in a first balance position.

FIG. 6 is a sectional view of the door braking device of FIG. 1 when the door is in a maximum open position.

FIG. 7 is a diagram showing the variation of the torque during opening of the door having the door braking device of FIG. 1.

FIG. 8 is a sectional view of the door braking device of FIG. 1 when the door is released using a door release actuator.

FIG. 9 is a perspective view illustrating an arrangement of the door braking device of FIG. 1 in a vehicle.

### DETAILED DESCRIPTION

Features and advantages of the invention will now be described in relation with an exemplary embodiment.

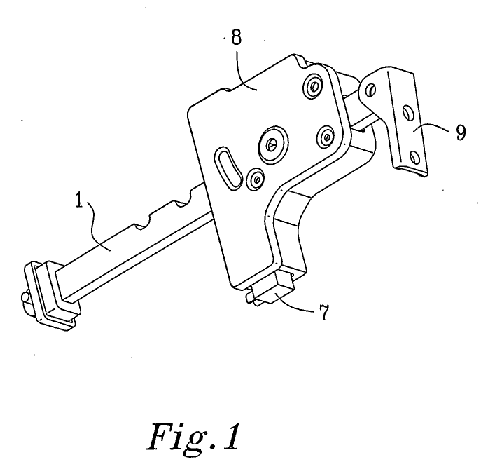

FIG. 1 is a perspective view of an embodiment of a door braking device according to the invention. A bar 1 is movable through a housing 8 in which the actual braking occurs. The bar 1 has a door connector 9 for connection to the door of a vehicle, and the housing 8 may be connected to the chassis of a vehicle. Thus, when the door is opened, the bar 1 will extend out from the housing 8 away from the chassis (to the right in FIG. 1). When the door is closed, the bar 1 will be retracted so that the door connector 9 of the bar 1 approaches the housing 8.

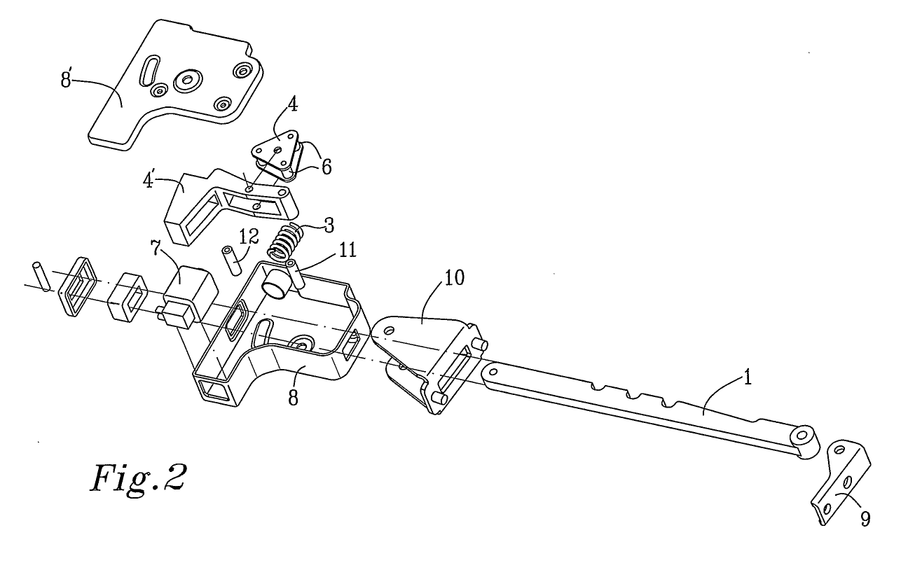

FIG. 2 is an exploded view of the door braking device of FIG. 1. The housing 8 comprises in this embodiment a housing body and a lid 8′. One end of a spring member, in this case a conventional spring 3, is arranged in the housing 8 in a fixed relationship to an inner wall of the housing 8. The other end of the spring member 3 is arranged to be in contact with a second link member 4′, in this case a lever arm, which is pivotally connected to the housing 8 at an end remote from the spring 3 via an axis 11. Between the axis 11 and the spring 3, a first link member 4, here in the shape of a link wheel, is attached to the second link member 4′ via a pivotal axis 12. The first link member 4 is provided with bar contact means 6 for forming a brake surface 2 when in contact with the bar 1. The bar contact means 6 may have the form of, e.g., a surface of the link member 4, but is advantageously formed by rotationally suspended means such as rollers.

In the illustrated embodiment, the link wheel 4 is triangular, and have bar contact means 6 in the shape of rollers rotably attached at each of the three corners of the triangle. Also, the lever arm 4′ is formed with an opening in which the link wheel 4 is rotably arranged. Also, the lever arm 4′ is L-shaped, so as to be pivotally suspended at the axis 11 at one end of the L. The spring member 3 is arranged to exert a pressure on lever arm 4′ at the elbow of the L.

A release actuator device 7 is arranged to affect the spring member 3, in this case via one of the link members, namely the lever arm 4′. In the illustrated embodiment, the release actuator device 7 is in the form of a pneumatic cylinder being arranged adjacent to the second end of the L-shaped lever arm 4′.

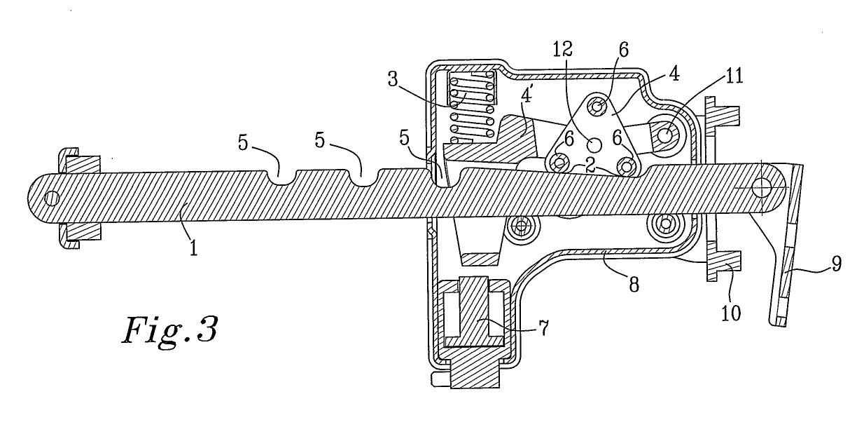

FIG. 3 illustrates the embodiment of the brake device when the door is closed. The bar 1 is in a retracted position. One of the link members, namely the first link member being the link wheel 4 is in its minimum pivotal position. Two of the bar contact means 6 are in contact with the movable bar 1, and thus together form the brake surface 2 through which the brake force is applied to the movable bar 1. The pivotal centre at the suspension axis 12 of the first link member is positioned at a distance from the brake surface 2 corresponding to the minimum radius of the first link member 4. The pivotal centre 12 is suspended on the second link member 4′, which is in contact with the spring member 3, in this case at its elbow. Accordingly, the spring member 3 exerts a spring force on the elbow of the lever arm 4′, which is transmitted via the link wheel 4 to the rollers 6 and applied to the movable bar 1.

The bar 1 has an outer profile, of which a first sloping portion and two indentations 5 are seen in FIG. 3. As the door is opened from the closed position the bar 1 will extend further out of the housing 8, i.e. move to the right in FIG. 3, resulting in the link wheel 4 being pressed against the initial sloping section of the bar 1. During this motion, the pivotal position of the first link member 4 will not change. However, the pivotal position of the second link member 4′ is affected, since the upward movement of the pivotal centre 12 of the first link member 4 results in a upward movement of second lever member 4′. This movement will increase the recoil of the spring member 3, resulting in an increasing brake force exerted from the brake surface 2 to the bar 1. Due to the arrangement of the second link member 4′ in the shape of a lever arm, the movement of the pivotal centre 12 of the first link member 4 is amplified resulting in the movement at the end of the lever arm 4′ being in connection with the spring being greater than the movement at the pivotal centre 12. Thus, a slight slope in the outer profile of the bar 1 will result in a notable increase in the recoil of the spring member. The person opening the door will feel an increasing resistance as the opening of the door progresses.

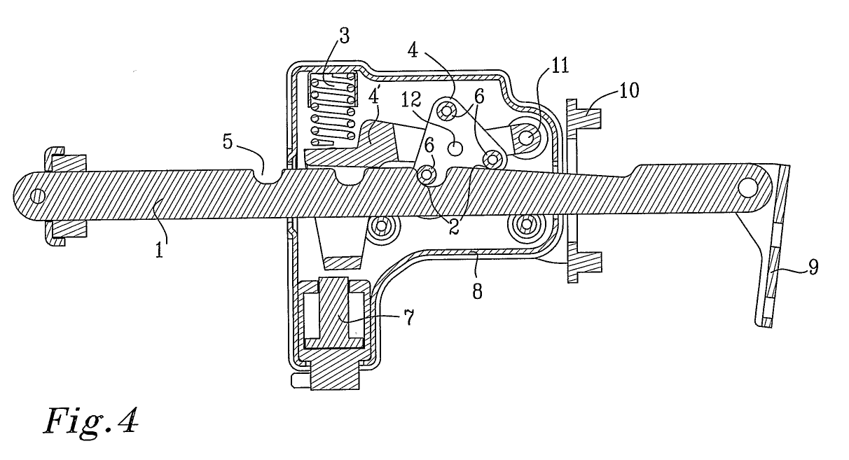

In FIG. 4, the bar 1 has reached a first stop position. The first roller 6 of the link wheel 4 has reached the first indentation 5 of the bar 1, and is situated in the indentation 5. However, both of the rolls 6 are still in contact with the bar. When the first roller 6 of the link wheel enters the indentation 5 from the previous slope, the pivotal axis 12 moves downwards in the figure, resulting in a slight extension of the spring member 3. Accordingly, the door is slightly accelerated to reach the first stop position.

In order to continue opening the door, the bar 1 must be further extended, i.e. moved further to the right in FIG. 4. The indentation 5 is shaped so as to keep the bar contact means 6 in the indentation 5 in this case, resulting in that further movement of the bar will rotate the first link member 4 counter clockwise in FIG. 4.

The rotation of the first link member 4 will increase the distance from the pivotal centre 12 to the bar contact means 6 in the indentation 5, as seen in the direction of recoil of the spring member 3. Thus, a relatively large recoil length of the spring member 3 is required to perform this movement. Accordingly, the person opening the door will feel an increasing braking force when opening the door further from the first stop position.

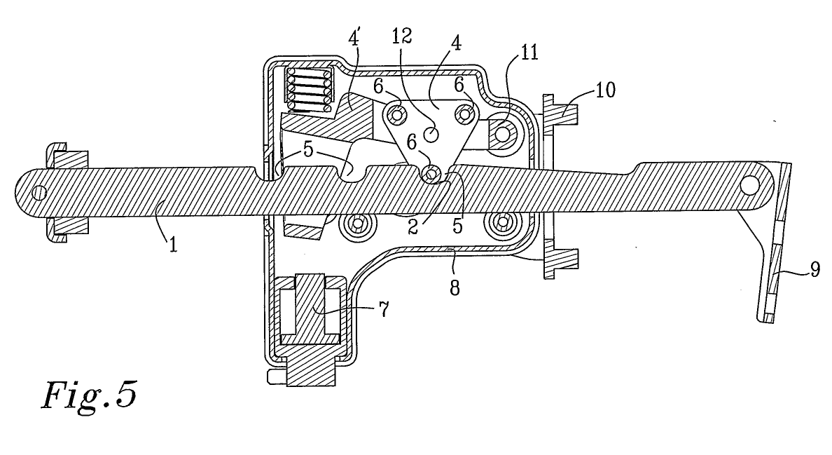

In FIG. 5, the door has been further opened from FIG. 4. The first link member 4 is in a maximum pivotal position, where the distance between the brake surface 2 being in contact with the bar 1 and the pivotal centre 12 is at its maximum. Accordingly, the spring member 3 is maximally compressed. Although the brake force 2 is at its maximum in this position, it is to be understood that the first link member 4 is in a balance, from which continued opening of the door will be without resistance, as the spring member 3 endeavouring to expand will accelerate the opening movement of the door.

In the case explained above, the first link member 4 tilts, meaning that it rotates in one direction only when passing the indentation. However, the configuration of indentations 5, the first link member 4 and the bar contact members 6 could be made so that the first link member 4 rotates in a first direction when a first roller descends into an indentation and in a second direction when the first roller leaves the indentation 5. In this case, no tilt of the first link member 4 will take place: the bar contact member 6 being the first when entering the indentation 5 will be the first also when leaving the indentation. In the case where no tilt occurs, the brake force will not vary as much as in the case where the tilt occurs. One way of avoiding tilting of the second link member 4 would be to provide an indentation forming a gentle slope having no sharp edges in relation to a planar part of the contact surface of the bar 1. The contact members 6 will descend and leave a gently sloping indentation 5 without becoming trapped therein, and thereby no tilt of the link wheel will occur. However, as described above, an indentation forming a close to right angle with the planar part of the contact surface will cause the contact member 6 to be trapped therein, causing a tilt of the link member 4 before the opening force is sufficient to cause the contact member to leave the indentation 5. Thus, a combination of tilts and “no tilts” may be used to design a desired braking behaviour of the door.

In the illustrated embodiment, the relation between the indentations 5 of the bar 1 and the first link member 4 is such that the rotation of the link member 4 when a bar contact member descends into an indentation 5 causes the recoil of the spring member to increase. In other words, the rotation alters the position of the first link member 4 so that the radius between the brake surface 2 and its pivotal centre 12 increases with a length being greater than the length of the depth of the indentation. Thus the contribution to the recoil length of the spring member is increased.

In contrast, a gentle slope of the profile of the bar 1, not causing the first link member 4 to rotate would, if sloping “inwardly”, cause the recoil of the spring member to decrease. Thus, it is to be understood that the first link member 4 when in its maximum or minimum position gives a maximum or maximum contribution, respectively to the recoil length of the spring member 3. However, depending on other contributions to the recoil of the spring member 3, the total recoil length of the spring need not necessarily be at its absolute minimum or maximum.

Thus, the profile of the bar 1 may be used to control the recoil length of the spring member 3 using different pivotal positions, tilts etc, to achieve the desired braking behaviour.

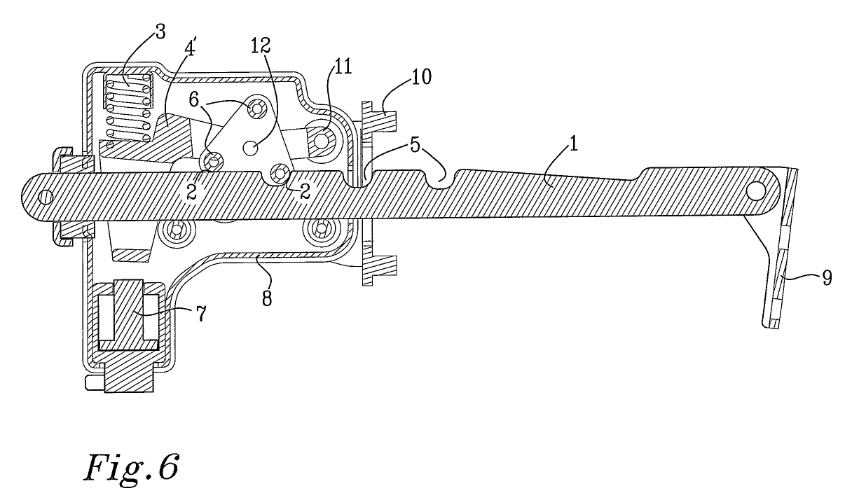

In FIG. 6, the door has reached its maximum open position, and the bar 1 is maximally extended from the housing 8 in the direction of the door. The first link member 4 is in a position with one of its bar contact members 6 in an indentation 5. This position is reached after the first link member 4 has assumed a balance position as illustrated in FIG. 4. The first link member 4 is in a minimum position, where the distance between the pivotal centre 12 and the brake surface 2, in this case formed by two of the bar contact members 6, is at its minimum.

In order to close the door from this position, the bar 1 must be retracted, i.e. moved to the left in FIG. 6. To do this, the first link member 4 must be rotated in the clockwise direction so as to assume a maximum pivotal position. This will in this case require a maximum recoil length (compression) of the spring 3, and thus a large brake force must be overcome in order to close the door.

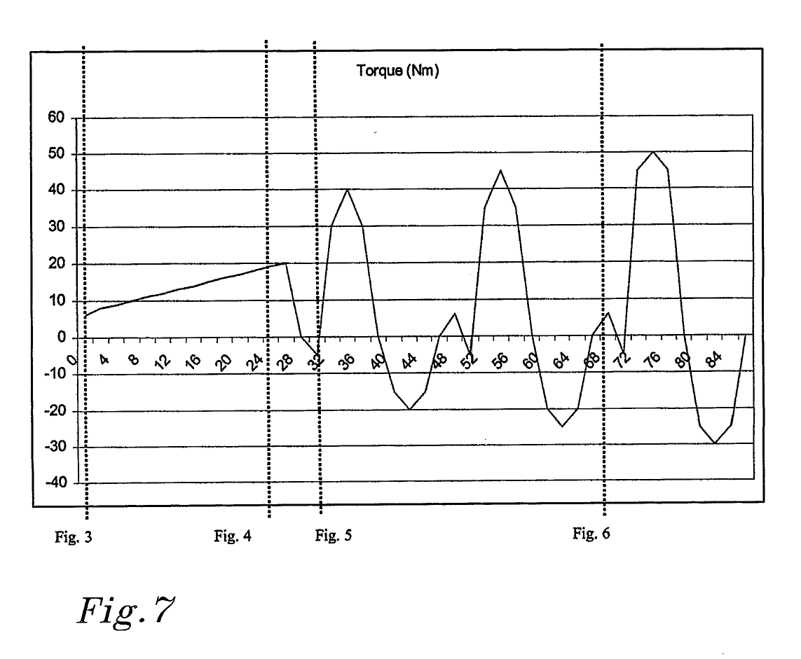

FIG. 7 is a diagram showing the torque needed on the door in order to overcome the brake force of the braking device in FIGS. 3 to 6. The initial slowly increasing torque corresponds to the initial slope of the bar 1, whereas the torque peaks correspond to tilting over of the tilt wheel 4 in order to overcome the indentations 5 of the profile of the bar 1. It is clearly seen how the transitions between the minimum pivotal position and the maximum pivotal position of the wheel effect an initial rise of the torque and a subsequent diminishing thereof. The torque values being less than zero indicate that the door strives to the next stable position from a balance position.

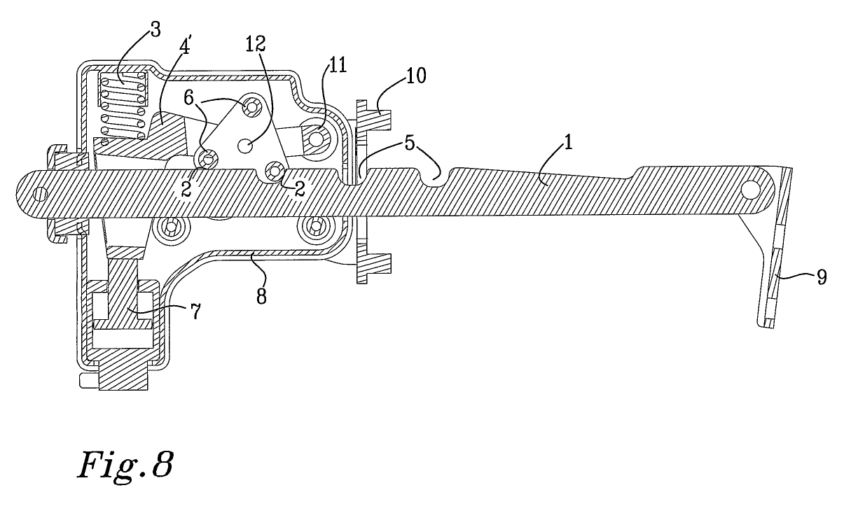

In FIG. 8, the door is in the maximally opened position as described in relation to FIG. 6. However, here, the braking force is removed by the action of a release actuator device 7. Since the link wheel 4 is in its first position, and consequently the recoil length of the spring is relatively short in this position, the spring may be additionally compressed for removing its action on the lever arm 4 using a relatively moderate force.

As can be seen if comparing FIG. 8 with FIG. 5, the recoil length needed to release the brake is actually less than the maximum recoil length (when the link wheel is in its maximum position).

In this case, the release actuator device 7 is a pneumatically controlled cylinder having a piston for exerting a pressure on the second link member 4′, thus compressing the spring 3 and lifting the first link member 4 out of the indentation 5 of the bar 1. Thus, the force from the release actuator device 7 is amplified vie the second link member 4′, being in the form of a lever arm, before reaching the spring member 3. Due to the relatively moderate force needed to release the brake device, a pneumatic system is sufficient for use. Advantageously, the release actuator device may be controlled by a control device provided in the vicinity of the inner handle of the door, and/or possibly at the outer handle of the door.

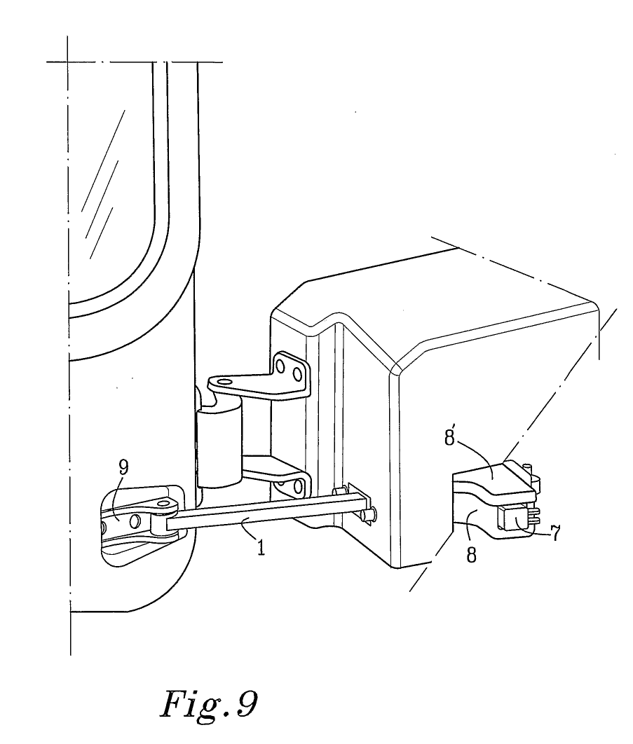

In FIG. 9, an example of the arrangement of an embodiment of a door braking device according to the invention in relation to a vehicle is depicted. The housing 8 is connected to the chassis of the vehicle, and the door connector 9 at the end of the bar 1 is connected to a vehicle door. In FIG. 9 the door braking device is arranged under the floor of a vehicle. This enables use of larger sized devices including larger lever arms, which in turn diminishes the required spring forces. Thus the lifespan of the device may be increased, and a larger maximum braking force is available.

Naturally, a number of alternative embodiments of the invention are possible. For example the link wheel could have various shapes, regular or irregular such as rectangular or oval. The length and shape of a lever arm could be adjusted to different requirements. In particular, the profile of the movable bar may be adjusted in relation to the pivotal link member (whether a wheel, a lever or both) so as to achieve a desired pattern of resistance and stop positions during opening or closing of the door. In the application, the profile of the movable bar has been described as including an “indentation”. It is to be understood that also a bar having a protrusion should be covered by this description, since an indentation would be the form of the profile next to the protrusion. The spring member could be any member suitable for biasing the brake surface towards to movable bar.

In the illustrated embodiment, the spring member is arranged so that the spring member is compressed and the recoil force is a result of the spring member striving to expand to its unstrained position. However, the invention is not restricted to this type of embodiment. For example, the spring member may instead be arranged so that the spring member is expanded from its unstrained position, whereby the recoil force is a result of the spring member striving to retract to its unstrained position.

1. A door braking device for a door of a vehicle, in particular a truck, the door braking device comprising
a bar movable between an extended position in which the door is fully opened, and a retracted position in which the door is closed,
a brake surface biased towards the bar by a spring member providing a recoil force being proportional to a recoil length of the spring member, such that the brake surface exerts a brake force on the bar for braking a movement of the door,
at least one link member pivotably arranged to transmit the spring force from the spring member to the brake surface, wherein the link member has at least a minimum pivotal position corresponding to a minimum contribution to the recoil length of the spring, and a maximum pivotal position corresponding to a maximum contribution to the recoil length of the spring being greater than the minimum contribution to the recoil length, the minimum and maximum contributions to the recoil length resulting in a minimum and a maximum contribution to a resulting brake force, respectively.

2. A door braking device according to claim 1, wherein the bar has an outer profile towards which the brake surface is biased, the outer profile having at least one indentation, and movement of the bar with the indentation past the brake surface results in a transition between the minimum and maximum pivotal positions of the link member.

3. A door braking device according to claim 2, wherein the link member is arranged in relation to the indentation such that the link member will assume its maximum position when at least a part of the brake surface is in contact with the indentation.

4. A door braking device according to claim 1, wherein the link member is arranged in relation to the brake surface, such that a distance between the pivotal centre of the link member and the brake surface measured in the recoil direction of the spring member when the link member is in the minimum pivotal position is less than the corresponding distance when the link member is in the maximum pivotal position.

5. A door braking device according to claim 1, wherein the link member is formed as a pivotal link wheel having a pivotal centre, and having a maximum radius extending from the pivotal centre to a brake surface, and a minimum radius extending from the pivotal centre to a second brake surface.

6. A door braking device according to claim 5, wherein the link wheel is pivotable from a first maximum pivotal position to a minimum pivotal position and further to a second maximum pivotal position by pivoting in one direction only.

7. A door braking device according to claim 5, wherein the link wheel has at least two maximum radii corresponding to two maximum positions, the maximum radii being equidistant radii extending from the pivotal centre, and the link wheel having a minimum radius extending from the pivotal centre of the link wheel perpendicular to the intersection of a straight imaginary axis between outer end points of the maximum radii.

8. A door braking device according to claim 5, wherein the link wheel comprises at least two bar contact means for contacting the bar and providing the brake surface the bar contact means being arranged at equidistant radii from the pivotal centre of the link wheel.

9. A door braking device according to claim 8, wherein the minimum position is a position in which both bar contact means contact the bar, and the maximum position is a position in which only one of the bar contact means contacts the bar.

10. A door braking device according to claim 8, wherein the link wheel comprises three bar contact means being arranged to form corners of an equilateral triangle.

11. A door braking device according to claim 8, wherein the bar contact means comprises a rotational roller.

12. A door braking device according to claim 1, wherein the link member forms an effective lever arm for transmitting recoil force to the brake surface, such that the resulting brake force exerted on the bar is greater than the recoil force produced by the spring member.

13. A door braking device according to claim 12, wherein the brake system comprises a first link member being the link wheel, and a second link member comprising a lever arm upon which the link wheel is rotably arranged.

14. A door braking device according to claim 13, wherein the lever arm is pivotally suspended by a pivotal suspension and extends a first distance from the pivotal suspension to the spring member, and the link wheel is rotably arranged on the lever arm at a second distance from the pivotal suspension thereof, the second distance being shorter than the first distance.

15. A door braking device according to claim 12, wherein a release actuator device is arranged to disable transmission of the recoil force to the bar when the pivotal link is in the minimum position.

16. A door braking device according to claim 15, wherein the release actuator device is arranged to affect the spring member for disabling transmission of the recoil force to the bar.

17. A door braking device according to claim 15, wherein the release actuator device is a pneumatically driven device.

18. A door braking device according to claim 15, wherein the brake system comprises a first link member being the link wheel, and a second link member comprising a lever arm upon which the link wheel is rotably arranged, and wherein the release actuator device is a piston of a pneumatic cylinder being arranged to compress the spring member via the link arm.

19. A door braking device according to claim 1, wherein, when the door is in the fully opened position, the link member is in a minimum position.

20. A door braking device according to claim 1, further comprising a housing from which the bar is extendible.

21. A door braking device according to claim 1, wherein the at least one link member is rotably arranged.
